(19) United States
(12) Patent Application Publication
(10) Pub. No.: US 2004/0002780 A1
(43) Pub. Date: Jan. 1, 2004

(54) Computer system with a preamplifier circuit mounted on a motherboard

(76) Inventor: Ting-Yu Chang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,766

(22) Filed: Nov. 18, 2002

(30) Foreign Application Priority Data
Jun. 28, 2002 (TW) 091114316

(51) Int. Cl. G06F 17/00

(52) U.S. Cl. 700/94

(57) ABSTRACT

A computer system includes a motherboard, a signal amplifier circuit integrated onto the motherboard, and a processor for controlling operations of the computer system. The signal amplifier circuit includes a Class-A preamplifier, a filament heating circuit, and a voltage booster and regulator circuit. The Class-A preamplifier has a vacuum tube so that the computer system can produce professional sound output.

### BACKGROUND OF INVENTION

1. Field of the Invention

The present invention relates to a computer system, and more particularly, to a computer system with a motherboard having a vacuum tube preamplifier circuit.

2. Description of the Prior Art

Personal computers have become a necessity in our modern life. What a personal computer can be used for is simply up to a user's imagination. Currently, IT vendors are working hard to port everything electric appliances can do to personal computers.

For example, during the period that the IBM® XT computer prevailed, game programmers could only utilize a simple circuit for generating single frequency music through a poor PC speaker. The other option for more enthusiastic players was to buy an optional sound card for better quality of sound. However, these kinds of sound cards could only generate MIDI music stored on a ROM chip, and only certain types of sound cards could deal with low quality wave sound. Additionally, most IBM-XT PCs were equipped with a monochrome CRT monitor, and thus could not display any colors other than white or green. Moreover, IBM-XT utilized a 16-bit Intel® 8088 microprocessor, running at 4.77 MHz, and yielded performance of less than 1 MIPS, which is far behind the minimum requirement for decoding MPEG video/audio (in general, 60 MIPS is required). Besides, most IBM-XT PCs had only two low-density, double-sided floppy disks, rarely any of them having a hard disk. Low volume disk storage meant the capacity of the software was limited, and for games, it is not hard to imagine that the games would be limited to text. On the contrary, game consoles during that period like Nintendo® or Sega® preformed much better in video, audio, and in overall entertainment. Therefore, in those days PCs could neither replace any electrical appliances nor any game consoles. PCs seemed to be nothing affiliated with our daily lives and were basically an advanced typing machine.

Now, computer technology has advanced rapidly in every extent. Performance of microprocessors, which was formerly measured in units of KIPS (kilo-instructions per second), is now measured in GIPS (giga-instructions per second). In mass storage, a 100 GB hard disk is becoming a basic standard accessory to a PC. This means a PC has more capacity for storing plenty of multimedia files so that games can be more realistic. Video card vendors do not emphasize the ability for displaying 2D windows-based environments any longer. Current video cards are mainly designed for displaying splendid and magnificent 3D scenes. And now, most sound cards are capable of outputting high-quality wave-files in real-time and simulating surrounding and environmental sound effects using powerful digital signal-processing chips.

All these technologies have improved a PC's multimedia ability significantly. To sum up, a PC with a mainstream 3D video card and a recent microprocessor, when connected to the Internet, allows a user to play 3D games with players from all around the world. With all these features, the PC's capability for playing games has almost bypassed that of game consoles. A PC with a TV-card allows users to watch TV programs and listen to FM radio broadcasts, and accordingly the users no longer need to buy a TV set or a radio. With an additional MPEG encoding card and a CD-RW, a user is able to record TV programs onto a CD for future viewing. With a CCD, a PC can act as video camera. With a DVD-ROM, a LCD-projector, a high-end sound card, and a corresponding speaker system, PC can make a home into a movie theater. With advances in design and the process of VLSI, these technologies have improved substantially. For example, there were formerly 13 IC chips required for DVD decoding, but because of the development of SOC technology, these 13 ICs have been integrated into one single chip.

The improvements of the last 20 years allows for tiny but extremely fast processing products, however, there are still things that VLSI cannot replace. One of these things is a speaker. There are two main types of speakers, vacuum tube amplifier and solid-state amplifier. Vacuum tube amplifier speaker systems have survived until now even though vacuum tube digital circuits have been extinct for a long time. This is due to a remarkable characteristic of vacuum tube amplifier speaker systems that is to cause amplified sound to be acoustically harmonic, clear, precise, and powerful. This is unreachable using a solid-state amplifier. Thus, audio professionals always prefer vacuum tube amplifier systems.

Current PCs are brilliant in audio and video functionality. When it comes to video, large-scale LCD projectors and plasma displays are available. However when it comes to audio, though high-end positional audio systems have been fulfilled in chip form, there is still a lack of corresponding high-end speaker systems.

### SUMMARY OF INVENTION

It is therefore a primary objective of the claimed invention to provide a motherboard having a vacuum tube preamplifier. Since devices on motherboard are complex, unlike a typical external vacuum tube amplifier, problems of signal interference and limited space are addressed by the claimed invention. Hence, the claimed invention must compress a vacuum tube preamplifier into a limited region on the motherboard in an environment having pluralities of clock signals and ICs.

According to the claimed invention, a computer system comprises a motherboard, a processor for controlling the computer system, and a signal amplifier circuit integrated on the motherboard. The signal amplifier circuit comprises an amplifier for amplifying an audio signal, wherein the amplifier comprises a vacuum tube for current amplifying the audio signal.

After installing the motherboard having the vacuum tube preamplifiers, the computer system according to the claimed invention is able to output acoustically harmonic, clear, precise, and powerful audio. This makes a PC equipped with the motherboard of the claimed invention not only a plain PC but also a professional preamplifier.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a computer system according to the present invention.

FIG. 2 is a schematic diagram of a class-A amplifier of the signal amplifier circuit of FIG. 1.

FIG. 3 is a schematic diagram of a voltage booster circuit of the signal amplifier circuit of FIG. 1.

FIG. 4 is a schematic diagram of a filament heating circuit of the signal amplifier circuit of FIG. 1.

### DETAILED DESCRIPTION

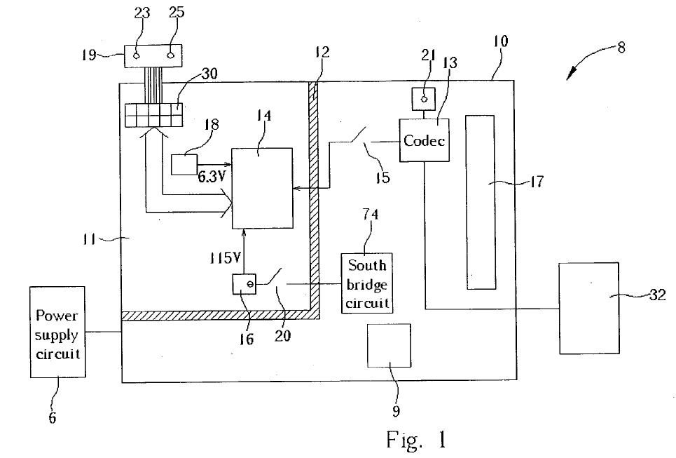

Please refer to FIG. 1. FIG. 1 is a schematic diagram of a computer system 8 according to the present invention. The computer system 8 comprises a processor 9, a motherboard 10, a signal amplifier circuit 11, an integrated sound chip 13, a first switch 15, a sound card 17 installed in a PCI expansion slot, and a frequency isolation wall 12. The integrated sound chip 13 is electrically connected to the signal amplifier circuit 11, wherein the first switch 15 determines the connection. The motherboard 10 automatically detects the setting of the first switch 15 to determine if the signal outputted from the integrated sound chip 13 goes through the signal amplifier circuit 11. Additionally, signals generated from the integrated sound chip 13 are directly outputted from a lineout port 21. The signal amplifier circuit 11 further comprises a riser card slot 30 and a corresponding riser card 19. The riser card 19 comprises a line-in port 23 and a lineout port 25. The line-in port 23 allows the sound card 17 in the PCI slot of the motherboard 10, a DVD-player 32, or any other external device to take advantage of the signal amplifier circuit 11 by plugging a signal cable into the line-in port 23. The lineout port 25 is for outputting the signal amplified by the signal amplifier circuit 11 to a next stage amplifier.

Please refer to the frequency isolation wall (FIW) 12 shown in FIG. 1. The FIW 12 is a signal isolation device for isolating the precision-demanding signal of the signal amplifier circuit 11 from complex clock signals and other digital signals of the motherboard 10. The FIW 12 substantially limits interference between circuits, devices, and ICs of the motherboard 10 and the signal amplifier 11.

Please refer to the signal amplifier circuit 11 shown in FIG. 1. When the computer system 8 starts up, a power supply 6 supplies the signal amplifier circuit 11 with 12V DC power. The signal amplifier circuit 11 comprises the following parts: a class-A current amplifier 14, a voltage booster circuit 16, a filament heating circuit 18, the riser slot 30, the riser card 19, and a second switch 20.

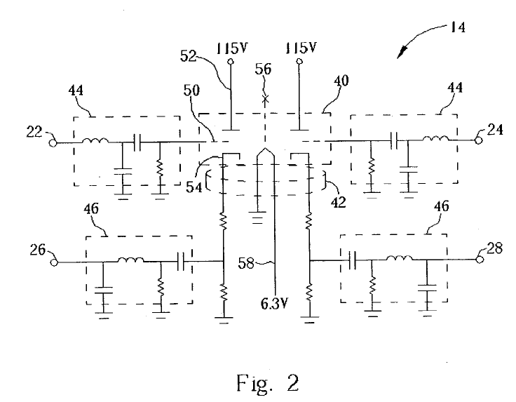

Please refer to FIG. 2, which is a schematic diagram of the class-A current amplifier 14 of the signal amplifier circuit 11 of the present invention. The class-A current amplifier 14 comprises a double triode 40, a vacuum tube holder 42, a left side input end 22, a right side input end 24, a left side output end 26, a right side output end 28, two input end filter circuits 44, and two output end filter circuit 46. The double triode 40 is made in a nine-pin style, which comprises two plate electrodes 52, two grid electrodes 50, two cathode electrodes 54, and a filament electrode 58. The signal inputted into the left side input end 22 and the right side input end 24 is then sent into the two input end filter circuits 44, and finally, the signal is inputted into the grid electrodes 50 of the double triode 40. After the signal is amplified by the vacuum tube, it is then inputted into the two output end filter circuits 44 and at last the signal is outputted from the left and right output ends 26, 28. The class-A current amplifier 14 has no effect of voltage amplification, and its other characteristics include large inputting impedance, low outputting impedance, with the input signal and the output signal being in phase. The signal amplifier circuit 11 can further comprise a voltage amplifier cascading with the class-A current amplifier 14 to obtain advantages of both a voltage amplifier and a current amplifier. A heating voltage of the filament electrode 58 of the double triode 40 is 6.3V and is supplied by the filament heating circuit 18. An operating voltage of the plate electrode 52 of the double triode 40 is 115V, which is supplied by the voltage booster circuit 16.

Capacitors of the two input end filter circuits 44 and 46 and grounded resistors connected to the cathode 54 of the double triode 40 can be adjusted according to user preferences. Adjusting the capacitors of the input end filter circuits 44 and 46 allows for changing frequency response of the filter circuits 44 and 46. Adjusting the grounded resistors connected to the cathode 54 allows for changing operating voltage of the whole class-A current amplifier 14. In addition, the double triode 40 of the class-A current amplifier 14 is plugged into the vacuum tube holder 42, which means that the vacuum tube is replaceable and changeable.

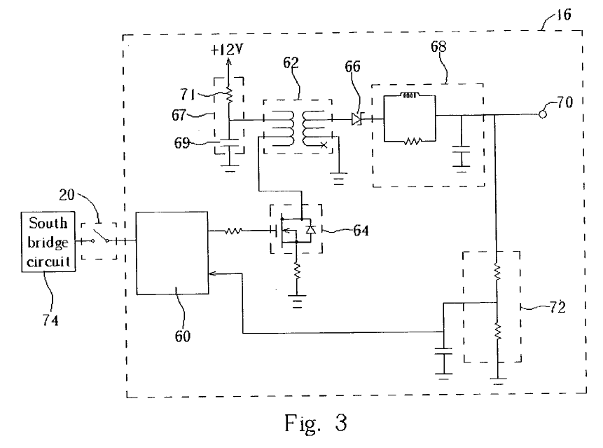

Please refer to FIG. 3, which is a schematic diagram of the voltage booster circuit 16 of the signal amplifier circuit 11 shown in FIG. 1. The voltage booster circuit 16 comprises a regulator 60, a transformer 62, a MOSFET 64, a Zener diode 66, and a low pass notch filter 68. 12V DC power is inputted into the transformer 62 from a power supply 67. Meanwhile, the regulator 60 outputs a high frequency clock to turn the MOSFET 64 on and off. Therefore, the supplied 12V DC power is converted to AC power that the transformer 62 can work with. After the AC power is stepped up, it is then inputted into the Zener diode 66 and the low pass filter 68 to be half-wave rectified by eliminating the AC portion of the power. The power is then sent into the plate electrode 52 of the double triode 40 of FIG. 2. The voltage output at the output end 70 of the voltage booster 16 then goes through a voltage divider 72, which divides the power and feedbacks to the regulator 60 for stability. In the preferred embodiment, the output voltage is 115V, and the second switch 20 is responsible for turning the regulator 60 on or off. One end of the second switch 20 is electrically connected to a south bridge chipset 74 on the motherboard 10. When the outputted signal from the south bridge chipset 74 goes high, the second switch 20 is turned off, and the entire signal amplifier circuit 11 is also turned off. On the other hand, if the outputted signal from the south bridge chipset 74 goes low, the second switch 20 is turned on and the entire signal amplifier circuit 11 is able to turn on.

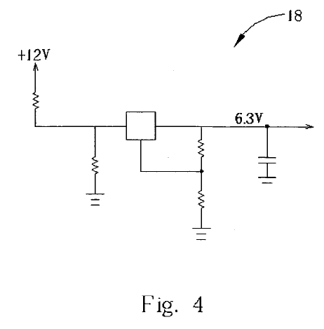

Please refer to FIG. 4, which is a schematic diagram of the filament heating circuit 18 of the signal amplifier circuit 11. The main purpose of the filament heating circuit 18 is to generate 6.3V DC power from the 12V DC power supplied by the motherboard 10, and then to heat the filament electrode 58 of the double triode 40 to an operating temperature in a short time.

Since DC power is supplied by the power supply 6 of the computer system 8, the signal amplifier circuit 11 does not need to include another power supply circuit, thus reducing space required. In addition, the signal amplifier circuit 11 has been designed to take full advantage of VLSI technologies in that fewer ICs and discrete devices appear on the motherboard 10. This makes the signal amplifier circuit 11 of the present invention perform substantially the same as a typical external vacuum tube amplifier, while consuming much less space.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A computer system comprising:
a motherboard; and
an audio circuit integrated on the motherboard, the audio circuit comprising a Codec IC and a vacuum tube amplifier, wherein the Codec IC outputs an audio signal to the vacuum tube amplifier to amplify the audio signal.

2. The computer system of claim 1 wherein the audio circuit further comprises an input end connected to the vacuum tube amplifier for inputting external audio signals, and an output end connected to the vacuum tube amplifier for outputting the amplified audio signal.

3. The computer system of claim 2 wherein the vacuum tube amplifier further comprises a first filter circuit connected between the audio circuit and the vacuum tube amplifier, and a second filter circuit connected between the audio circuit and a vacuum tube of the vacuum tube amplifier.

4. The computer system of claim 3 wherein the audio circuit further comprises a filament heating circuit for heating a filament of the vacuum tube to an operating temperature, and a voltage booster to provide the vacuum tube an operating voltage.

5. The computer system of claim 2 wherein the external audio signals are generated by a sound card plugged into the motherboard or by a DVD player.

6. The computer system of claim 1 further comprising a first switch connected between the Codec IC and the audio circuit, the first switch when turned on inputs the audio signal outputted from the Codec IC into the audio circuit.

7. The computer system of claim 1 wherein the Codec IC outputs the audio signal to a lineout port mounted on the motherboard.

8. The computer system of claim 1 further comprising a second switch connected to the audio circuit and a south-bridge chip for outputting a control signal to start up or shut down the audio circuit.

9. The computer system of claim 1 further comprising a power supply connected to the motherboard for providing DC power to the motherboard.

10. The computer system of claim 1 further comprising a frequency isolation wall for isolating the audio circuit from interference from other devices.

11. The computer system of claim 1 wherein the vacuum tube amplifier is a class-A current preamplifier.

12. The computer system of claim 11 wherein the audio circuit further comprises a voltage amplifier for cascading with the class-A current preamplifier.

13. The computer system of claim 1 wherein the vacuum tube is a 9-pin double-triode vacuum tube.

14. A motherboard comprising:
a Codec IC for processing an audio signal;
a vacuum tube amplifier circuit for amplifying the audio signal outputted from the Codec IC with a replaceable vacuum tube; and
a vacuum tube power supply circuit for supplying voltage and current to the vacuum tube amplifier circuit.

15. A method for improving audio quality in a motherboard having a Codec IC for processing an audio signal, the method comprising:
providing a vacuum tube amplifier circuit for amplifying the audio signal with a vacuum tube, wherein the Codec IC outputs the audio signal to the vacuum tube amplifier circuit; and
providing a vacuum tube power supply circuit for supplying voltage and current to the vacuum tube amplifier circuit.

16. The method of claim 15 further comprising replacing resistors and capacitors of the vacuum tube amplifier circuit to change amplifying characteristics of the vacuum tube amplifier circuit.

17. The method of claim 15 further comprising providing a first switch connected between the Codec IC and the vacuum tube amplifier circuit, the first switch when turned on inputs the audio signal outputted from the Codec IC into the vacuum tube amplifier circuit.

18. The method of claim 15further comprising providing a second switch connected to the vacuum tube amplifier circuit and a south-bridge chip for outputting a control signal to start up or shut down the vacuum tube amplifier circuit.

19. The method of claim 15 further comprising providing a frequency isolation wall for isolating the vacuum tube amplifier circuit.

20. The method of claim 15 wherein the vacuum tube amplifier circuit further comprises a filament heating circuit for heating a filament of the vacuum tube to an operating temperature, and a voltage booster to provide the vacuum tube an operating voltage.
